(19) United States
(12) Patent Application Publication
(10) Pub. No.: US 2026/0321934 A1
(43) Pub. Date: Oct. 15, 2026

(54) HOUSING FOR A MODULE POLE CONNECTION FOR PROVIDING TOUCH PROTECTION, MODULE POLE CONNECTION, CONNECTING ASSEMBLY AND BATTERY MODULE FOR A MOTOR VEHICLE

(71) Applicant: AUDI AG, Ingolstadt (DE)

(72) Inventor: Christopher MÜLLER, München (DE)

(73) Assignee: AUDI AG, Ingolstadt (DE)

(21) Appl. No.: 19/484,453

(22) PCT Filed: May 7, 2024
(86) PCT No.: PCT/EP2024/062592

§ 371 Date: Nov. 14, 2025

(30) Foreign Application Priority Data
May 16, 2023 (DE) 102023112888.4

(51) Int. Cl. H01M 50/593; H01M 50/588; H01R 4/34; H01R 4/70; H01R 11/26

(52) U.S. Cl. CPC H01M 50/593; H01M 50/588; H01R 4/34; H01R 4/70; H01R 11/26; H01R 2201/26

(57) ABSTRACT

A housing for a module pole connection providing touch protection for the module pole connection. The housing has a module pole busbar with a contact region and is connected in a connecting direction to a module connector and is electrically contacted via the contact region. The housing is electrically insulating, and receives the module pole busbar, and has a first housing wall which has a recess region with at least one recess for exposing at least part of the contact region of the module pole busbar when the module pole busbar is received as intended in the housing. The first housing wall has a recess edge region surrounding the recess region in a radial direction. The first housing wall has an electrically insulating insulation ring radially within the recess region, which is connected to the recess edge region via at least one insulation web.

### FIELD

The invention relates to a housing for a module pole connection for providing touch protection for the module pole connection, which housing has a module pole busbar with a contact region and which can be connected to a module connector in a connecting direction and can be electrically contacted via the contact region. The housing is designed to be electrically insulating and is designed to receive the module pole busbar, wherein the housing has a first housing wall which has a recess region with at least one recess for exposing at least part of the contact region of the module pole busbar when the module pole busbar is in a state in which it is received in the housing as intended, wherein the first housing wall has a recess edge region which surrounds the recess region in the radial direction. Furthermore, the invention also relates to a module pole connection, a connecting assembly and a battery module for a motor vehicle.

### BACKGROUND

In order for such a module pole connection to be electrically contacted with a corresponding module connector, in particular via a plug connection, it is generally necessary for the corresponding contact surface or contact region of the module connector to be exposed so that electrical contact can be established with a corresponding contact element provided by the module connector. Especially in the high-voltage sector, it is important to ensure sufficient safety for the assembly personnel when assembling and installing battery modules, especially when electrically connecting and plugging the corresponding module connectors into the module pole connections. The electrical contacts should, if possible, be provided with touch protection. There are different definitions and standards for such touch protection, depending on the application. If there is sufficient touch protection, the assembly personnel may not need to wear protective clothing, which simplifies assembly. To protect people against electric shock, it is therefore advantageous to have touch protection at the electrical interface. The touch protection of existing connection systems is usually implemented using several components, in particular special components such as protective pins, contact sleeves, electrically insulating caps, etc. at both interface parameters. This makes the corresponding connection systems very complex and also requires a relatively large amount of installation space. Another aspect that should be considered when designing such connecting assemblies between a module pole connection and a module connector is to design them in such a way that electrical losses are kept to a minimum. This increases efficiency, which is particularly relevant in connection with high-voltage storage systems, especially for motor vehicles, since energy losses reduce the range of the corresponding vehicle in which such a high-voltage storage system is used. In addition, the consequence of increased contact resistance is a correspondingly increased heat input via the high-voltage connectors connected to the cell module. This in turn has a negative impact on service life and performance and should therefore be avoided as far as possible. In order to achieve the lowest possible contact resistance in a small installation space, the screw connection has become established. Here, high forces can be introduced into the contact via the screw, which allows a high surface pressure and thus a low contact resistance to be achieved.

DE 20 2018 100 111 U1 describes a module connector for batteries of electric-drive vehicles, wherein the module connector is formed with two connection parts that can be electrically connected to one another, to each of which a conductor element can be attached at a conductor point and which each have a mutually compatible fastening element. Each connection part is provided with a touch protection on its connection side facing the other connection part, which protection has an outer electrically insulation collar and an electrically insulated protective pin surrounded by the collar, wherein on at least one connection part between the collar and the protective pin there is a current bridge electrically connecting the two conductor points, which is projected over by the collar and the protective pin, wherein the current bridge is designed as a contact sleeve.

At least the connection part with the additional contact sleeve is designed in a complex manner and requires a lot of installation space in the axial direction due to the protruding collar and the insulating pin. In addition, a coding can be provided radially outside the outer insulation collar, which significantly increases the required installation space in the radial direction.

Further connecting assemblies with touch protection are described, for example, in DE 10 2015 216 543 A1 and in DE 10 2020 208 149 A1 .

### SUMMARY

The object of the present invention is to provide a housing for a module pole connection, a module pole connection, a connecting assembly and a battery module, which enable a touch protection for a module pole connection to be provided in the most space-saving but nevertheless efficient way possible.

This object is achieved by a housing, a module pole connection, a connecting assembly and a battery module in the embodiments. Advantageous embodiments of the invention are the subject matter of the description, and the figures.

A housing according to the invention for a module pole connection for providing touch protection for the module pole connection, which housing has a module pole busbar with a contact region and which can be connected to a module connector in a connecting direction and can be electrically contacted via the contact region, is designed to be electrically insulated and for receiving the module pole busbar. In addition, the housing comprises a first housing wall which has a recess region with at least one recess for exposing at least part of the contact region of the module pole busbar when the module pole busbar is in a state in which it is received in the housing as intended. In addition, the first housing wall has a recess edge region which surrounds the recess region in the radial direction. In addition, the first housing wall comprises an electrically insulating insulation ring radially within the recess region, which ring is connected to the recess edge region via at least one insulation web.

The invention is based on the one hand on the realization that it is possible, by providing at least one insulation web extending from a central insulation ring to the recess edge region of the housing surrounding the recess region, to reduce the effective recess surface area or to subdivide it into individual segments, whereby touch protection can advantageously also be provided, in a significantly more space-saving manner than, for example, in the form of a collar projecting far in the axial direction or a central insulating pin or the like. In addition, the invention is based on the finding that one or more such insulation webs can provide further advantageous functions, in addition to touch protection, in a space-saving manner and can be integrated into the housing. On the one hand, this allows additional torque support to be provided, in particular for a screwing process for connecting the module connection with the corresponding module connector. As explained in more detail later, in order to be able to make contact with a module connection comprising such a housing, the module connector can have a slot or a slot-shaped recess corresponding to at least one web at its corresponding contacting point. If such a module connector and a corresponding module connection are electrically connected to each other, the at least one electrically insulating insulation web is located in this slot of the module connector. A twisting between the module connector and the module connection is then no longer possible or not possible up to a certain torque, since the insulation web counteracts this torque. This in turn means that a screw connection between such a module connection and the corresponding module connector can be carried out more easily due to the simplified position-keeping. This leads to an increase in efficiency during assembly. Over the service life, this can provide a stable connection between such a module connection and the corresponding module connector and prevent unwanted twisting between the module connector and the module pole connection. Another major advantage is that such a web can optionally be used to implement position coding in a particularly simple manner, particularly in the case of several insulation webs being provided. Such coding is therefore not implemented radially outside the contact region or, with respect to the housing, radially outside the recess region, but can be integrated directly into the recess region, which in turn saves enormous installation space, especially in the radial direction. In addition, no additional, separate contact sleeve is required, which must be contacted with the contact region of the module pole busbar. In general, a particularly simply designed housing for a module pole connection and also a particularly simply designed module pole connection can be provided here, which nevertheless make it possible to provide touch protection and at the same time do so in a particularly space-saving and efficiency-enhancing manner.

In order to make the housing electrically insulating, the housing can be made of an electrically insulating material. A design with an electrically conductive core that is, for example, covered on all sides by an electrically insulating material would also be conceivable. However, it is preferred for the housing to be made entirely of an electrically insulating material, as this significantly simplifies the manufacture of the housing. In particular, this can be provided, for example, in an injection molding process or similar. The housing can generally be designed in one piece or in several parts, although a design with as few parts as possible is preferred. A two-part design with an upper and lower shell as described in more detail later is advantageous in order to enable easy accommodation of the module pole busbar and, if necessary, other components, as explained in more detail below. The first housing wall and the recess geometry for providing the touch protection can be made in one piece. In other words, the insulation ring, the at least one insulation web, the recess edge region around the recess region and the remaining first housing wall can be formed in one piece, for example in an injection molding process.

An insulation web is generally understood to be an elongated component made of an electrically insulating material. The recess edge region, which surrounds the recess region, is in particular directly adjacent to the recess region in the radial direction. The recess edge region delimits the recess region in the radial direction. The recess region represents the region of the first housing wall in which the at least one or more recesses are arranged, in particular in the radial direction around the insulation ring. The recess region can be defined by the totality of the recesses. The recesses can be separated by insulation webs. This means that the recess region does not have to be a continuous region. The recess region can also be defined in such a way that, in addition to the recesses, it also comprises at least one or more insulation webs. In this case, the recess region is a continuous region through which the at least one insulation web passes.

According to an exemplary embodiment, the first housing wall can be substantially flat. In this case, the latter may have a slight elevation in the region of the insulation ring, the recess edge region and the at least one insulation web, but the insulation ring, the insulation web and the recess edge region do not have to be significantly elevated relative to a base plane of the first housing wall in order to provide touch protection. The insulation ring, the at least one insulation web and the recess edge region can therefore be elevated relative to the base plane of the first housing wall, wherein this elevation is, for example, of the same order of magnitude as the thickness of the first housing wall in a non-elevated region. In other words, the first housing wall in the region of the insulation ring, the insulation web and the recess edge region can be approximately twice as thick as in the regions of the first housing wall radially adjacent to the recess edge region. The elevation is therefore particularly small overall. Rather, the touch protection can be provided by reducing the opening in the first housing wall, which must be penetrated in order to come into contact with the contact region, by providing at least one insulation web. The insulation ring of the first housing wall surrounds a circular opening, in particular a central circular opening. As explained in more detail below, a fastening means, for example a screw, can be inserted into this in order to fix the module connection to a corresponding module connector. Therefore, no additional insulation pin that is elevated axially far above the base plane of the first housing wall needs to be provided within the insulation ring. This also saves a lot of installation space.

According to a further exemplary embodiment, the insulation ring and/or the recess edge region and/or the at least one insulation web can also be elevated, in particular significantly more elevated than described above, relative to the surrounding housing wall. This makes it possible, for example, to provide even better touch protection or to increase the distance between the insulation webs in the circumferential direction and/or the radial distance between the insulation ring and the recess edge region while maintaining the same level of touch protection.

The module pole connection for which the housing is intended is part of a battery module. A battery module, in particular for a high-voltage battery of a motor vehicle, can have two such module pole connections. Each of these two module pole connections can be assigned to one of the two potentials of such a battery module, namely a positive potential and a negative potential. A high-voltage battery for a motor vehicle can comprise many of such battery modules. These can be electrically connected to each other via appropriate module connectors and wired accordingly. For this purpose, for example, a first module pole connection of a first battery module can be electrically connected to a second module pole connection of a second battery module via such a module connector. Such a module connector can essentially also be formed with a busbar which is encased in electrical insulation, in particular except for the corresponding contact regions via which the busbar is to be contacted with the corresponding module pole connections.

The at least one recess is designed as an opening in the first housing wall. In other words, a recess is understood to be an opening in the first housing wall. As a result, when the module pole busbar is in a state in which it is received in the housing as intended, the contact region of this busbar is accessible from outside the housing through this recess and can thus be contacted by a corresponding second contact region of the module connector.

By providing at least one insulation web, it is now possible not only to provide a single, closed, ring-shaped recess in the recess region, but also to subdivide and divide this recess into several recess segments, for example. The individual recesses can thus be significantly reduced in size. This can, for example, increase touch protection, but also provide torque support via the individual insulation webs.

Therefore, it represents a further particularly preferred embodiment of the invention if the first housing wall comprises a plurality of insulation webs which connect the insulation ring and the recess edge region to one another, so that the recess region is divided by the insulation webs into a plurality of recess segments, each of which provides a recess. The recess region therefore has several recesses separated from each other by the insulation webs. Each recess surface area is significantly smaller than the area of the entire recess region, thereby increasing touch protection. Likewise, significantly better torque support can be achieved.

The insulation webs can be designed as elongated connecting elements that extend from the central insulation ring to the recess edge region surrounding the recess region. The insulation webs can run in a radial direction. The radial direction, as preferably defined within the scope of the present invention, refers, for example, to the center of the recess region or the insulation ring. If, for example, the module connection is connected as intended to a module connector and fixed, for example, via a screw connection, the axis of this screw connection can run through this center of the recess region or through the center or middle of the insulation ring. The radial direction is therefore defined starting from this center of the insulation ring. Accordingly, an axial direction can be defined perpendicular to the radial direction and, for example, be essentially perpendicular to the base plane of the housing wall. The axial direction is parallel to the connecting direction in which the module pole connection can be connected to the module connector. The axial direction may run along a central axis of a screw connection between the module connection and the module connector. Since, as described above, the use of a screw connection is extremely advantageous for fixing a module pole connection to a corresponding module connector, it is preferred that the opening surrounded by the insulation ring is circular. The outer side of the insulation ring facing the recess edge region of the first housing wall can in principle be designed with any geometry, including a polygonal geometry, for example square or n-sided. But here too, a circular geometry has proven to be particularly space-efficient in order to provide the largest possible contact area in a minimal installation space. Accordingly, the recess region as a whole is preferably ring-shaped, although here again any geometric shape would be possible.

Therefore, it represents a further advantageous embodiment of the invention if the recess region is ring-shaped and the respective recess segments are designed as circular ring sectors. The ring-shaped design of the recess region or the circular sector-shaped design of the recess segments allows the contact region to be maximized while simultaneously providing touch protection in a minimal installation space.

In a further advantageous embodiment of the invention, at least two of the plurality of recess segments are of different sizes and/or have a different geometric shape. This advantageously provides at the same time coding or protection against accidental incorrect connection to the module connector. The primary function of this coding is to ensure that the two module connections usually present on a battery module cannot be exchanged. In other words, a first module connector designed to couple to a first module connection of a battery module should not be able to be connected to the second module connection of that battery module. This can advantageously be prevented by the aforementioned coding, which can be provided by the size and/or shape of the recess segments. Two module connections or the corresponding housings of the module connections of a battery module can differ with regard to the geometric design of their recess segments. This advantageously prevents the module connections from being mixed up and incorrectly connected. At the same time, such coding can also ensure that the module connector can only be coupled to the module connection by means of a plug connection in a specific position relative to the module connection. This also advantageously enables correct alignment of the module connector relative to the module connection. This in turn facilitates the space-optimized, correct positioning of the module connector relative to the module connection.

In a further advantageous embodiment of the invention, the insulation webs extend in the radial direction and subdivide the full angle around an imaginary central axis through a center of the insulation ring into circular sectors with respective associated center angles. In order to provide the above-mentioned coding, it is very advantageous, for example, if the insulation webs are arranged in such a way that the center angles assigned to the resulting circular sectors are of different sizes. To provide coding, it is sufficient if at least two of these center angles are different. This allows position coding to be provided in a particularly simple and reliable manner.

In a further advantageous embodiment of the invention, the housing has a first housing component, in particular an upper shell, which comprises the first housing wall, and a second housing component, in particular a lower shell, which can be arranged or is arranged on the first housing component to form an interior space of the housing in which the module pole busbar can be received. Preferably, the two housing components are manufactured as separate components and can be connected to one another by a suitable joining connection to provide the housing, for example by clipping. The respective housing components, namely the first and the second housing component, are each preferably formed in one piece. The number of components required to provide a module connection can thus be reduced or even minimized. This means that the module pole busbar can also be easily arranged in the housing, for example by inserting it between the two housing components and then connecting the housing components to one another, for example by clipping them together.

Furthermore, the invention also relates to a module pole connection with a housing according to the invention or one of its embodiments. The advantages described in relation to the housing according to the invention and its embodiments apply in the same way to the module pole connection according to the invention.

In another very advantageous embodiment of the invention, the module pole connection has a module pole busbar with a contact region and the module pole connection can be connected to a module connector in a connecting direction and can be electrically contacted via the contact region. Furthermore, the module pole busbar is arranged in an interior space of the housing, so that at least a part of the contact region is exposed through the at least one recess of the recess region of the housing.

In a further advantageous embodiment of the invention, the module pole busbar has a through-opening which is surrounded in the radial direction by the contact region and through which a fastening means, in particular a screw, for fastening the module pole connection to a module connector can be passed. In this way, a fixation between the module pole connection and a corresponding module connector can advantageously be realized, wherein this fastening is preferably designed as a screw connection. The fastening means is preferably designed to be elongated in the axial direction. The easiest way to connect the module pole connection to a module connector is to use a screw as the fastening means. Such a screw can therefore be formed with an external thread at least in sections along its screw neck. In particular, the lower part of the screw, which is thus opposite the screw head, is designed with such an external thread. In principle, however, it is also conceivable that the fastening means is designed as a screw device with an internal thread, for example within an internal thread provided in the screw neck. However, such a design requires more installation space in the axial direction, especially on the side of the module pole connection. The design as a screw with an external thread enables a particularly simple design of the coupling counterpart on the module pole connection, which can then be designed in particular as a nut.

According to a further advantageous embodiment of the invention, the module pole connection comprises a coupling element, in particular a nut, for coupling to the fastening means, wherein the coupling element is arranged on a side of the module pole busbar facing away from the contact region and the first housing wall of the housing and is fixed to the module pole busbar. This fixation can be achieved, for example, by pressing or welding the coupling element onto the module pole busbar. The module pole busbar is preferably made of copper. This enables particularly good, low-loss current conduction. The coupling element, which is in particular made of metal, is preferably not made of copper, i.e. of a different metallic material than the module pole busbar, for example of steel. This enables a much more stable screw connection due to the significantly greater hardness of steel compared to copper, for example.

The fastening means described above is also preferably made of a metallic material. In particular, the fastening means is preferably made of steel. This allows a particularly stable connection to be created between the module pole connection and the module connector, which remains stable over a long period of time, in particular over the lifetime of a battery module. Due to the creep properties of plastic, it is preferred that no plastic components are involved in this screw connection between the module pole connection and the module connector. The force-fitting of the screw connection is thus realized exclusively via metallic components.

Furthermore, the invention also relates to a connecting assembly having a module pole connection according to the invention or one of its embodiments. The advantages described for the module pole connection according to the invention and its embodiments, and in particular the advantages described with respect to the housing according to the invention and its embodiments, apply equally to the connecting assembly according to the invention.

Furthermore, it is advantageous if the connecting assembly has a module connector which can be connected and electrically contacted in a connecting direction with the module pole connection via the contact region, in particular wherein the contact region of the module pole connection represents a first contact region and the module connector has a, in particular ring-shaped, second contact region which can be electrically contacted with the first contact region, wherein the second contact region has at least one slot-shaped recess into which the at least one insulation web of the housing is received when the module connector is connected to the module pole connection.

The second contact region of the module connector can therefore be formed with a corresponding number of slot-shaped recesses, just as the housing of the module pole connection has insulation webs. The insulation webs and the slot-shaped recesses of the second contact region also correspond to each other in terms of their geometric arrangement. This advantageously makes it possible to ensure that by plugging the module pole connection together with the module connector, the first and second contact regions are electrically conductively contacted with one another, i.e. in particular they touch one another over a large region. By means of the screw connection described above, which can preferably also be part of the connecting assembly, the two contact regions can be additionally fixed to one another and pressed together when in contact with one another. This reduces contact resistance and maximizes conduction efficiency.

The module connector can also include a busbar. The second contact region can be provided by this busbar. In other words, the second contact region and the remaining busbar can be formed in one piece and integrally, for example by forging. In addition, the busbar can also be encased in a housing. This has a corresponding recess, for example a circular recess, in the region of the second contact region. The second contact region, which can be designed, for example, as a ring-shaped region segmented by the recess and elevated relative to the housing plane of the module connector, thus projects slightly beyond the housing of the module connector. This makes it easy to ensure that the second contact region, in particular the individual contact sections, can be inserted into the corresponding recesses of the housing of the module pole connection and thus contacted with the first contact region. This means that no additional contact sleeve is required. This in turn saves components.

Furthermore, the invention also relates to a battery module for a motor vehicle which has at least one module pole connection according to the invention or one of its embodiments. The advantages mentioned for the module pole connection according to the invention and the housing according to the invention and its embodiments thus apply similarly to the battery module according to the invention. The battery module preferably has two module pole connections according to the invention or two module pole connections according to exemplary embodiments of the invention. These preferably differ in the geometry and/or size of their respective recess segments, so that a module connector which can be connected to a first of the two module pole connections and can be electrically contacted with its contact region cannot be electrically contacted with the contact region of a second module pole connection of the two module pole connections. This advantageously prevents the connections from being mixed up, as already described above.

The invention also includes developments of the module pole connection according to the invention, of the connecting assembly according to the invention and of the battery module according to the invention, which have features as already described in connection with the developments of the housing according to the invention. For this reason, the corresponding developments of the module pole connection according to the invention, of the connecting assembly according to the invention and of the battery module according to the invention are not described again here.

Furthermore, the invention also includes a motor vehicle having a battery module according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic and perspective cross-sectional representation of a module pole connection according to an exemplary embodiment of the invention;

FIG. 2 shows a schematic and perspective representation of a module pole connection in a plan oblique view from above according to an exemplary embodiment of the invention;

FIG. 3 shows a schematic and perspective representation of a module pole connection to illustrate the function of torque support according to an exemplary embodiment of the invention.

FIG. 4 shows a schematic and perspective representation of a module pole connection with a coding implemented by the touch protection according to a further exemplary embodiment of the invention.

FIG. 5 shows a schematic and perspective representation of a module connector for a connecting assembly according to an exemplary embodiment of the invention; and

FIG. 6 shows a schematic and perspective cross-sectional representation of a connecting assembly with a module pole connection and a module connector, which are electrically conductively coupled to one another, according to an embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

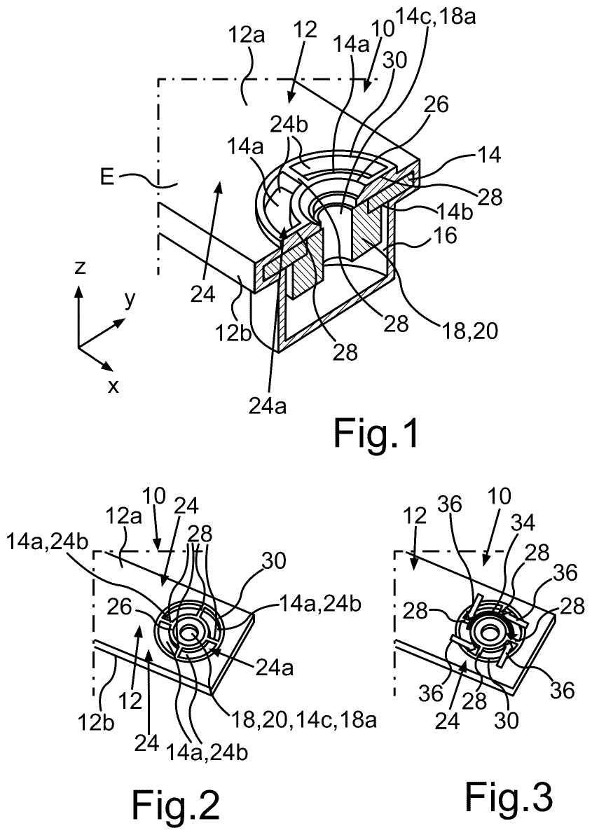

FIG. 1 shows a schematic and perspective cross-sectional representation of a module pole connection 10 according to an exemplary embodiment of the invention. The module pole connection 10 has a housing 12 according to an exemplary embodiment of the invention. The housing 12 may, for example, comprise an upper housing part 12a and a lower housing part 12b, which are designed as separate components in order to simplify the integration of a module pole busbar 14, which is also part of the module pole connection 10. The housing upper part 12a and the housing lower part 12b, when arranged relative to one another, as shown in FIG. 1, thus form a corresponding interior space 16 in which the module pole busbar 14 already mentioned is arranged. The top side is defined here with respect to the z-direction shown. However, the installation positions of the module pole connection 10 and in particular also of the module connector 32 may deviate from this in the specific application.

The module pole busbar 14 is made of electrically conductive material, for example copper. The housing 12, on the other hand, is designed to be electrically insulating, for example made of an electrically insulating material, for example a plastic. The module pole connection 10 also has a coupling element 18, which in this example is designed as a nut 20, which is arranged on the underside, i.e. on a side 14b of the module pole busbar 14 facing the housing lower part 12b, for example is pressed into the module pole busbar 14 or a central opening 14c provided thereby or is welded to it. This nut 20 or, in general, this coupling element 18 also provides a central opening 18a, which can therefore be designed as a nut 20 with an internal thread into which a corresponding screw 22 (cf. FIG. 5 and FIG. 6) can be screwed. For stability reasons, the coupling element 18 may be made of a different material than the busbar 14, for example steel. The busbar 14 has a contact region 14a. The housing 12 has a housing wall 24, which was previously also referred to as the first housing wall 24, and which is part of the housing upper part 12a. In addition to this first housing wall 24, the housing 12 may also have other housing walls, which are not described in more detail here. This first housing wall 24 comprises a recess region 24a in which at least one recess 24b, in this example multiple recesses 24b, are arranged, which expose the contact region 14a of the busbar 14.

The special feature of this housing 12 is that the first housing wall 24 comprises an insulation ring 26 which is arranged radially within the recess region 24a and has at least one insulation web 28, in the present example multiple insulation webs 28, which connect this central insulation ring 26 to a recess edge region 30 which surrounds the recess region 24a in the radial direction and is also part of the first housing wall 24. The recess edge region 30, the insulation ring 26 and the at least one insulation web 28 can be slightly elevated relative to a base plane E or the remaining region of the first housing wall 24, which is arranged immediately radially outside the recess edge region 30 and adjoins it. The base plane E runs parallel to the x-y-plane of the coordinate system shown here.

By means of the aforementioned insulation webs 28, which extend in particular from the insulation ring 26 radially outwards to the circumferential recess edge region 30 and are spaced apart from one another in the circumferential direction, touch protection can now advantageously be provided, because in this way the recess region 24a can be subdivided into many small recess segments, which are provided by the individual recesses 24b. In addition, these webs 28 can perform further advantageous functions.

FIG. 2 shows a schematic and perspective view of the module pole connection 10 from FIG. 1. This can be designed as described for FIG. 1. In this perspective view it can be seen that the housing 12 in this example comprises four such insulation webs 28. In principle, however, more or fewer than four such insulation webs 28 are also conceivable. For example, only one such insulation web 28, but preferably at least two such insulation webs 28, or three insulation webs 28 may be provided. More than four insulation webs 28 are also conceivable, for example five or six such webs.

FIG. 3 again shows a schematic and perspective view of the module pole connection 10 from FIG. 2. The insulation webs 28 not only advantageously provide insulation protection in a particularly space-saving manner, but also additionally provide torque support. If the screw 22 already mentioned is screwed to establish the connection between the module pole connection 10 and a corresponding module connector 32 (see FIG. 5) with the screw 22 already mentioned, a certain torque, which is illustrated by the arrow 34, is exerted on the module pole connection 10 via the screw 22. This torque 34 can now be counteracted by a certain counterforce by the individual insulation webs 28, which is illustrated by the arrows 36. This makes it easier to establish the screw connection, as the module pole connection 10 can be held securely in position with respect to the module connector 32. The torque support can therefore be used to enable or facilitate maintaining the position during assembly.

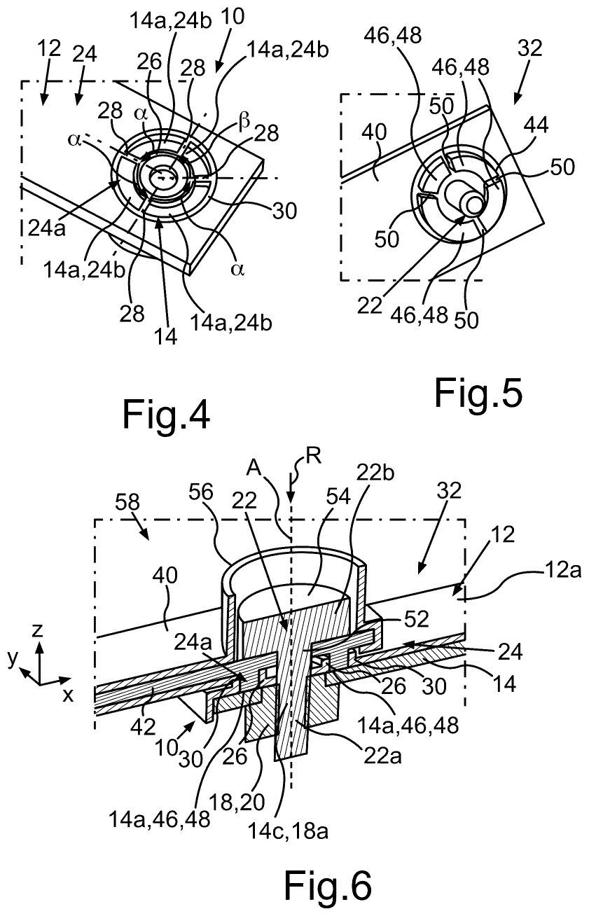

In addition, the insulation webs 28 do not have to be equally spaced from one another in the circumferential direction as shown in FIG. 2 and FIG. 3, but can also have different spacing from one another in order to provide coding, as illustrated in FIG. 4. The insulation webs 28 subdivide the full angle around a central axis A, which is parallel to a connecting direction R (cf. FIG. 6), into individual circular sectors, each of which is assigned a center angle a, B. At least two of these center angles α and β differ. In this example, three of these center angles α are equal, while one of these center angles ß is smaller than the others. This results in recesses 24b of different sizes.

FIG. 5 shows a schematic representation of a corresponding module connector 32, which is designed in particular for connecting and electrically contacting the module pole connection 10 from FIG. 4. This correspondingly also comprises a busbar 42 encased in a housing 40, wherein the housing 40 comprises a circular recess 44 through which a part of the busbar 42 is exposed, namely that part of the busbar 42 which provides a second contacting surface 46. The first contacting surface 14a of the module pole busbar 14 is contacted via this contacting surface 46 when the module pole connection 10 and the module connector 32 are arranged and connected to one another as intended, as illustrated in a schematic and perspective cross-sectional view in FIG. 6. The second contact region 46 is also subdivided into individual segments 48. This can be seen particularly well in FIG. 5. The individual segments 48 are separated from one another by slot-shaped recesses 50 or spaced from one another in the circumferential direction. The corresponding insulation webs 28 of the module pole connection 10 can be received in these recesses 50. If the module pole connection 10 and the module connector 32 are connected to each other as intended, as shown in FIG. 6, the insulation webs 28 are received in the corresponding recesses 50 of the module connector 32.

The module connector 32 has a central through-opening 52 centrally with respect to this second contact region 46, which can be seen in particular in cross-section in FIG. 6. The aforementioned screw 22 can be passed through this with its screw neck 22a, which is provided with an external thread in some sections, at least at the lower end opposite the screw head 22b.

FIG. 6 shows a connecting assembly 58 with a module pole connection 10 and a module connector 32, which can be designed in particular as previously described, wherein the screw 22 is now in a state in which it is passed through the through-opening 52 of the module connector 32, and in particular in a state in which it is screwed to the nut 20 of the module pole connection 10. The housing 40 of the module connector 32 may also have an opening in the region of the screw head 22b to enable the screw 22 to be screwed in. This opening 54 may be radially enclosed by an insulation collar 56 provided as part of the housing 40. This provides touch protection for screw 22. For reasons of clarity, the lower housing part 12b is not explicitly shown in FIG. 6.

Overall, the examples show how the invention provides a touch-protected module pole with implementation of torque support and coding while insulating the current-carrying interface. This advantageously eliminates the need for a central protective pin on the module pole. The designs described also make it possible to continue to ensure touch protection in accordance with IPXXB at the module pole, i.e. at the module pole connection, by designing or modifying the insulating housing in such a way that touch protection is still provided even without an additional cap. This is made possible by the insulation webs described. A suitable design of this insulating housing of the current-carrying interface, i.e. the module pole connection, ensures torque support and thus also anti-twist protection. A suitable design of the insulating housing of the current-carrying interface, i.e. the module pole connection, also ensures optional coding. This makes it possible to provide a space- and material-saving implementation of a torque support as well as a space-and material-saving implementation of a coding. At the same time, touch protection according to IPXXB can also be implemented at the module pole connection in an advantageous and space-saving manner. The touch protection at the module pole can be provided by a suitable extension of the insulating housing. According to advantageous embodiments, the solution can be implemented with only a few components, such as the busbar received in the housing, which serves as a current conductor and interface to the high-voltage connector, the threaded sleeve into which the screw can be screwed and with which the high-voltage connector can be screwed to the module pole, and the insulating housing, which in the best case, as a one-piece solution or with a one-piece upper shell, can represent the touch protection of the module pole. By means of a suitable design of the touch protection on the module pole, the function of torque support when screwing the high-voltage connector can be realized. The forces can then be absorbed by the insulating housing. Coding can be realized by using different geometric shapes and/or sizes for the passage through or to the high-voltage connector interface. This can be used to avoid incorrect installation. The counter-interface on the high-voltage connector can then also be provided with this coding. The coding can be implemented directly in the busbar.

1-10. (canceled)

11. A housing for a module pole connection for providing touch protection for the module pole connection, which has a module pole busbar with a contact region and which can be connected in a connecting direction to a module connector and can be electrically contacted via the contact region,
wherein the housing is electrically insulating,
wherein the housing receives the module pole busbar,
wherein the housing has a first housing wall which has a recess region with at least one recess for exposing at least part of the contact region of the module pole busbar when the module pole busbar is in a state in which it is properly received in the housing,
wherein the first housing wall has a recess edge portion surrounding the recess portion in a radial direction,
wherein the first housing wall comprises an electrically insulating insulation ring radially within the recess region, which is connected to the recess edge region via at least one insulation web.

12. The housing according to claim 11, wherein the first housing wall comprises a plurality of insulation webs which connect the insulation ring and the recess edge region to one another, so that the recess region is divided by the insulation webs into a plurality of recess segments, each of which provides a recess.

13. The housing according to claim 11, wherein the recess region is ring-shaped and the respective recess segments are formed as circular ring sectors.

14. The housing according to claim 11, wherein at least two of the plurality of recess segments are of different sizes and/or have a different geometric shape.

15. The housing according to claim 11, wherein the housing has a first housing component, in particular an upper shell, which comprises the first housing wall, and a second housing component, in particular a lower shell, which can be arranged or is arranged on the first housing component to form an interior space of the housing in which the modular pole busbar can be received.

16. A module pole connection with a housing according to claim 11, wherein the module pole connection has a module pole busbar with a contact region, and can be connected to a module connector in a connecting direction and can be electrically contacted via the contact region, wherein the module pole busbar is arranged in an interior space of the housing such that at least part of the contact region is exposed through the at least one recess of the recess region of the housing.

17. The module pole connection according to claim 16, wherein the module pole busbar has a through-opening which is surrounded in the radial direction by the contact region and through which a fastening means, in particular a screw, can be passed through to fasten the module pole connection to a module connector.

18. The module pole connection according to claim 16, wherein the module pole connection has a coupling element, in particular a nut, for coupling to the fastening means, wherein the coupling element is arranged at least in part on a side of the module pole busbar facing away from the contact region and the first housing wall of the housing and is fixed to the module pole busbar.

19. A connecting assembly with a module pole connection according to claim 16, wherein the connecting assembly has a module connector which can be connected and electrically contacted in a connecting direction with the module pole connection via the contact region, in particular wherein the contact region of the module pole connection represents a first contact region and the module connector has a second in particular ring-shaped contact region which can be electrically contacted with the first contact region, wherein the second contact region has at least one slot-shaped recess in which the at least one insulation web of the housing is received when the module connector is connected to the module pole connection.

20. A battery module for a motor vehicle, wherein the battery module has two module pole connections according to claim 16, which differ in the geometry and/or size of their respective recess segments, so that a module connector which can be connected to a first of the two module pole connections and can be electrically contacted with its contact region cannot be electrically contacted with the contact region of a second module pole connection of the two module pole connections.

21. The housing according to claim 12, wherein the recess region is ring-shaped and the respective recess segments are formed as circular ring sectors.

22. The housing according to claim 12, wherein at least two of the plurality of recess segments are of different sizes and/or have a different geometric shape.

23. The housing according to claim 13, wherein at least two of the plurality of recess segments are of different sizes and/or have a different geometric shape.

24. The housing according to claim 12, wherein the housing has a first housing component, in particular an upper shell, which comprises the first housing wall, and a second housing component, in particular a lower shell, which can be arranged or is arranged on the first housing component to form an interior space of the housing in which the modular pole busbar can be received.

25. The housing according to claim 13, wherein the housing has a first housing component, in particular an upper shell, which comprises the first housing wall, and a second housing component, in particular a lower shell, which can be arranged or is arranged on the first housing component to form an interior space of the housing in which the modular pole busbar can be received.

26. The housing according to claim 14, wherein the housing has a first housing component, in particular an upper shell, which comprises the first housing wall, and a second housing component, in particular a lower shell, which can be arranged or is arranged on the first housing component to form an interior space of the housing in which the modular pole busbar can be received.

27. The module pole connection according to claim 17, wherein the module pole connection has a coupling element, in particular a nut, for coupling to the fastening means, wherein the coupling element is arranged at least in part on a side of the module pole busbar facing away from the contact region and the first housing wall of the housing and is fixed to the module pole busbar.
